(19) United States
(12) Patent Application Publication
(10) Pub. No.: US 2015/0356689 A1
(43) Pub. Date: Dec. 10, 2015

(54) DATA PROCESSING SYSTEM IN WHICH DATA RECEIVED FROM DATA COLLECTION TERMINALS ARE CONVERTED FOR EFFICIENT SEARCHING

(71) Applicant: TOSHIBA TEC KABUSHIKI KAISHA, Tokyo (JP)

(72) Inventor: Tsuyoshi GOTANDA, Ota Tokyo (JP)

(21) Appl. No.: 14/729,459

(22) Filed: Jun. 3, 2015

(30) Foreign Application Priority Data
Jun. 4, 2014 (JP) 2014-115898

(51) Int. Cl. G06Q 40/00; G06Q 20/20

(52) U.S. Cl. CPC G06Q 40/12; G06Q 20/202

(57) ABSTRACT

A data processing system in which data received from a plurality of data collection terminals are converted for efficient searching includes a first data collection terminal configured to collect transaction data in a first format and convert the transaction data into a structured format, a second data collection terminal configured to collect transaction data in a second format and convert the transaction data into the structured format, a central server connected to the first and second data collection terminals over a first network and configured to collect the transaction data in the structured format from the first and second data collection terminals and store the collected transaction data in a storage unit, and a client device connected to the central server over a second network. The client device issues one or more queries according to the structured format to the central server.

### CROSS-REFERENCE TO RELATED APPLICATION

This application is based upon and claims the benefit of priority from Japanese Patent Application No. 2014-115898, filed Jun. 4, 2014, the entire contents of which are incorporated herein by reference.

### FIELD

Embodiments described herein relate generally to a data processing system, in particular, a data processing system in which data received form a plurality of data collection terminals are converted for efficient searching.

### BACKGROUND

Typically, stores in a complex, such as a shopping mall, are operated by a plurality of tenants that are different entities from an operator of the complex. In some cases, the operator of the complex requires each of the tenants to report sales data (transaction data) of the stores for each predetermined period, such as a day, a week, or a month.

The sales data may be generated by a point-of-sale (POS) terminal in each store, and then the sales data may be collected by a server of the operator directly connected to the POS terminal in each store. Alternatively, the sales data may be collected and stored by a server (central server) different from the server of the operator, and the operator of the complex may collect the sales data by accessing the central server. The POS terminals used by the tenants may be different types and thus may generate the sales data in different formats. It would be preferable for the central server to efficiently search the sales data requested by the operator of the complex.

### DESCRIPTION OF THE DRAWINGS

FIG. 1 illustrates an entire structure of an electronic receipt system according to an embodiment.

FIG. 2 is a block diagram of a POS terminal in the electronic receipt system.

FIG. 3 is a memory map of a RAM in a control unit of the POS terminal.

FIG. 4 is a block diagram of an electronic receipt server in the electronic receipt system.

FIG. 5 is a block diagram of an electronic receipt management server in the electronic receipt system.

FIGS. 6 and 7 each are a memory map of a storage unit in the electronic receipt management server.

FIG. 8 is a block diagram of a portable terminal in the electronic receipt system.

FIG. 9 is a block diagram of a store server in the electronic receipt system.

FIG. 10 is a functional block diagram of the POS terminal.

FIG. 11 is a flowchart of a flow of control processing carried out by the POS terminal.

FIG. 12 is a flowchart of a flow of control processing carried out by the electronic receipt server.

FIG. 13 is a functional block diagram of the electronic receipt management server.

FIG. 14 is a flowchart of a flow of control processing carried out by the electronic receipt management server.

FIG. 15 is a flowchart of a flow of control processing carried out by the portable terminal.

FIG. 16 is a flowchart of a flow of control processing carried out by the store server.

FIG. 17 illustrates an example of a display screen of a display unit in the store server.

### DETAILED DESCRIPTION

An embodiment provides a data processing system that can search data received from a plurality of data collection terminals efficiently and provide the searched data.

In general, according to one embodiment, a data processing system in which data received from a plurality of data collection terminals are converted for efficient searching includes a first data collection terminal configured to collect transaction data in a first format and convert the transaction data into a structured format, a second data collection terminal configured to collect transaction data in a second format and convert the transaction data into the structured format, a central server connected to the first and second data collection terminals over a first network and configured to collect the transaction data in the structured format from the first and second data collection terminals and store the collected transaction data in a storage unit, and a client device connected to the central server over a second network. The client device issues one or more queries according to the structured format to the central server.

Hereinafter, an embodiment will be described with reference to the accompanying drawings. In the embodiment, a POS terminal is described as an example of a merchandise sales data processing apparatus. Further, an electronic receipt management server is described as an example of an information processing apparatus. This technology is not limited to the following described embodiment.

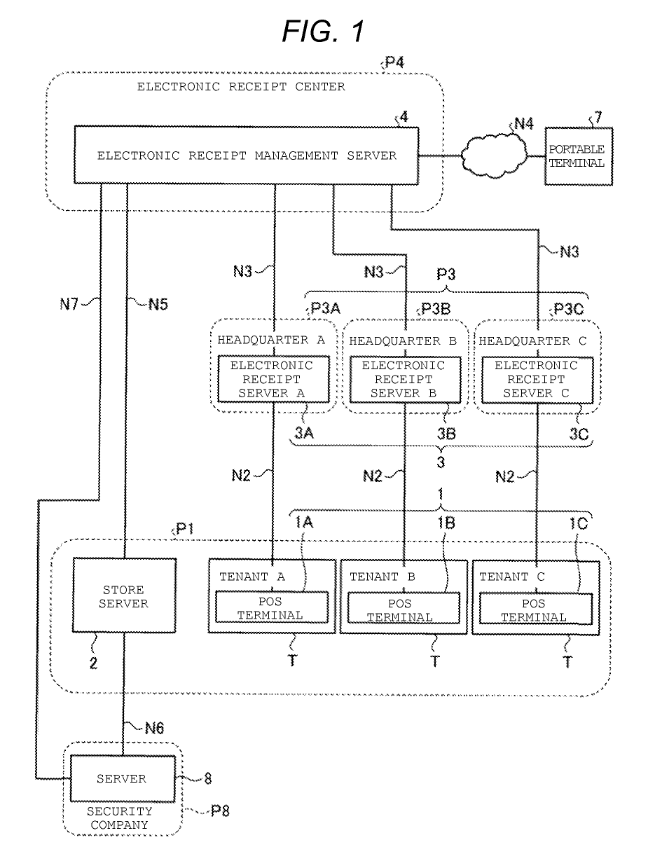

FIG. 1 illustrates the entire structure of an electronic receipt system (data processing system) according to an embodiment. As illustrated in FIG. 1, an electronic receipt system includes point of sales (POS) terminals 1 each of which is installed in one of tenants T, a plurality of electronic receipt servers 3 each of which is installed in one of the headquarters P3 of a company operating the corresponding one of the tenants T, an electronic receipt management server 4 which is installed in the electronic receipt center P4, a portable terminal 7 which is carried by a customer and specifies the customer, and a store server 2 which is installed in the store P1 by a developer that operates a shopping center.

The POS terminals 1 and the store server 2 are provided in the store P1. The store P1 corresponds to a shopping center, and the store P1 includes many tenants T operated by companies which are different from a company that manages the entire store P1, in addition to a food store, a clothing store, or the like which is directly operated by the store P1. In the embodiment, the tenants T in the store P1 include a tenant A operated by a company A, a tenant B operated by a company B, and a tenant C operated by a company C (collectively the tenant A, tenant B, and tenant C are referred to as the tenant T). In the embodiment, a POS terminal 1A is installed in the tenant A. A POS terminal 1B is installed in the tenant B. A POS terminal 1C is installed in the tenant C. Here, the POS terminal 1A, the POS terminal 1B, and the POS terminal 1C are collectively referred to as the POS terminal 1.

The POS terminal 1 is connected to a network N2 that connects the store P1 and the headquarter P3. For example, the network N2 is a dedicated line such as the Internet and a virtual private network (VPN).

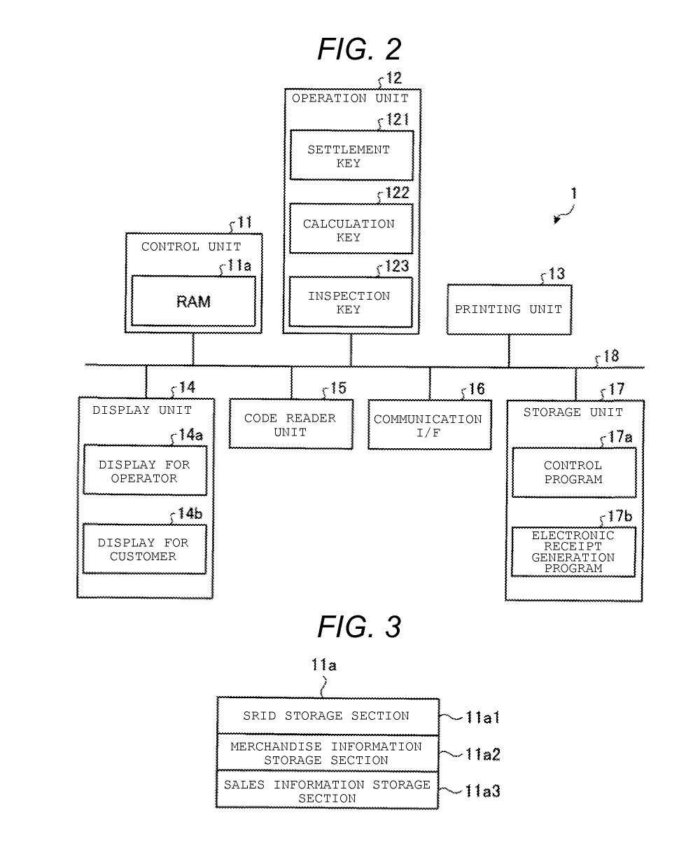

The POS terminal 1 is a merchandise sales data processing apparatus and executes merchandise sales data processing in the corresponding tenant T. The POS terminal 1 generates receipt information, which is transaction printing information including content of purchase transaction such as purchased merchandise, and causes a printing unit 13 (FIG. 2) to print the receipt information, and thus issues a paper receipt. The POS terminal 1 of each tenant T generates electronic receipt information by converting a non-structured format of receipt information, which is a first data format, into a structured format, which is a second data format different from the non-structured format. The electronic receipt information is receipt information obtained by converting receipt information which is originally to be printed in a receipt sheet into receipt information having the structured format such as a comma-separated values (CSV) type and a J-son type, for example. The electronic receipt information is transmitted to the electronic receipt management server 4 through the electronic receipt server 3 and the transmitted electronic receipt information is stored in the electronic receipt management server 4. The electronic receipt information which is stored in the electronic receipt management server 4 may be transmitted to the portable terminal 7 and be viewed therewith. The portable terminal 7 displays the electronic receipt information in substantially the same format as that of receipt information which is printed in a receipt sheet.

All of receipt information which is generated by the POS terminal 1A, receipt information which is generated by the POS terminal 1B, and receipt information which is generated by the POS terminal 1C are configured in the same format of the non-structured format. All of electronic receipt information which is generated by the POS terminal 1A, electronic receipt information which is generated by the POS terminal 1B, and electronic receipt information which is generated by the POS terminal 1C are configured in the same format of the structured format.

The POS terminal 1 of each tenant T outputs (transmits) the generated electronic receipt information to the electronic receipt server 3 through the network N2. A transmission method of the electronic receipt information is not particularly limited, and may use a general protocol such as HTTP and HTTPS. The number of the POS terminals 1 which is provided in the store P1 is not particularly limited, and may be plural. The POS terminal 1A which is provided in the tenant A, the POS terminal 1B which is provided in the tenant B, and the POS terminal 1C which is provided in the tenant C are POS terminals 1 of different manufacturers from each other.

The store server 2 manages sales in the entire store P1. The store server 2 manages sales information of each tenant T, based on sales information in the POS terminal 1 of the tenant T. The store server 2 collects the sales information of the tenant T as accumulated receipt information. The accumulated receipt information corresponds to information obtained by accumulating sales information regarding sales during a predetermined period of time (for example, one day) in the tenant T. The accumulated receipt information corresponds to information obtained by accumulating the sales information in accordance with sectors or classes, for example, in addition to total sales information for the predetermined period of time. For example, the accumulated receipt information corresponds to information obtained by accumulating the sales information in accordance with payment types. For example, the accumulated receipt information corresponds to information obtained by accumulating the sales information in accordance with time zones. For example, the accumulated receipt information corresponds to information obtained by accumulating the sales information in accordance with tenants. In addition, the accumulated receipt information may include information obtained by accumulating the sales information in accordance with other various categories.

The electronic accumulated receipt information corresponds to electronic information obtained by converting the accumulated receipt information in the non-structured format into information in the structured format. The accumulated receipt information is originally prepared to be printed in a receipt sheet, and the non-structured format is the first data format. The structured format is the second data format such as the comma-separated values (CSV) type and the J-son type, for example. The electronic accumulated receipt information is electronic information having the same content as those of the accumulated receipt information. The electronic accumulated receipt information is generated based on the accumulated receipt information by the POS terminal 1 at timing when a calculation key 122 is operated. The electronic accumulated receipt information is transmitted from the POS terminal 1 to the electronic receipt management server 4 through the electronic receipt server 3 and is stored in the electronic receipt management server 4.

The electronic accumulated receipt information is configured to have the same structure as that of the electronic receipt information. For this reason, all of electronic accumulated receipt information which is generated by the POS terminal 1A, electronic accumulated receipt information which is generated by the POS terminal 1B, and electronic accumulated receipt information which is generated by the POS terminal 1C are configured to have the same format of the structured format.

The electronic receipt server 3 is provided in the headquarter P3 of a company which operates the corresponding tenant T. The electronic receipt server 3 functions as a receipt management server company which manages the receipt information of the company which operates the corresponding tenant T. In the embodiment, a headquarter P3A of a company corresponds to the tenant A, a headquarter P3B of a company corresponds to the tenant B, and a headquarter P3C of a company corresponds to the tenant C. Here, the headquarter P3A, the headquarter P3B, and the headquarter P3C are collectively referred to as the headquarter P3.

An electronic receipt server 3A is installed on the headquarter P3A. An electronic receipt server 3B is installed on the headquarter P3B. An electronic receipt server 3C is installed on the headquarter P3C. Here, the electronic receipt server 3A, the electronic receipt server 3B, and the electronic receipt server 3C are correctively referred to as the electronic receipt server 3.

The electronic receipt server 3 receives electronic receipt information transmitted from the POS terminal 1 through the network N2. The electronic receipt server 3 transmits the received electronic receipt information to the electronic receipt management server 4 through a network N3 that connects the headquarter P3 and the electronic receipt center P4.

For example, the network N3 is a dedicated line such as the Internet and a virtual private network (VPN). A transmission method of the electronic receipt information is not particularly limited, and may use a general protocol such as HTTP and HTTPS.

The electronic receipt management server 4 is provided in the electronic receipt center P4. For example, the electronic receipt center P4 manages the electronic receipt information and the electronic accumulated receipt information of multiple companies each of which manages receipt information using the electronic receipt server 3. The electronic receipt management server 4 is a third party organization other than the companies which manage the electronic receipt servers 3. Alternatively, the third party organization and the like may manage the electronic receipt server 3.

The electronic receipt management server 4 functions as the receipt management server for customer which manages integrally electronic receipt information of multiple companies which operate stores. The electronic receipt management server 4 stores and manages a membership code, a unique terminal code (SRID which will be described below), and membership data, in a membership master which is contained in a database DB. The membership code is the name or a customer code of a customer (member) which is registered as a member. The terminal code specifies the portable terminal 7. The membership data includes transmission destination information (for example, mail address) of the portable terminal 7 which is a transmission destination of the electronic receipt information. A membership management server for storing and managing the membership data may be provided separately in addition to the electronic receipt management server 4.

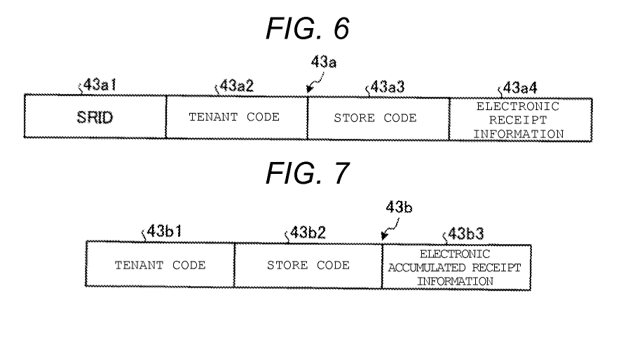

The electronic receipt management server 4 receives electronic receipt information transmitted from the electronic receipt server 3 through the network N3. The electronic receipt management server 4 stores and manages the received electronic receipt information in an electronic receipt information region 43a4 of an electronic receipt management section 43a, which is contained in the database DB (see FIG. 6). More specifically, the electronic receipt information includes store information of a store which transmits the electronic receipt information, the membership code, and the like in addition to the content (merchandise sales data) of the purchase transaction. The electronic receipt information is managed in association with membership data of a member.

If electronic receipt information is stored in the database DB, the electronic receipt management server 4 specifies a transmission destination (portable terminal 7) with reference to transmission destination information associated with a membership code in the stored electronic receipt information. The electronic receipt management server 4 notifies a transmission destination that there is electronic receipt information to be transmitted, through a network N5.

If an inquiry of an electronic receipt, which designates a membership code, is received from the portable terminal 7 which is connected through a network N4, the electronic receipt management server 4 extracts electronic receipt information corresponding to the designated membership code from the database DB, and transmits the extracted electronic receipt information to the portable terminal 7. When additional information is associated with the electronic receipt information, this additional information is also transmitted to the portable terminal 7 which has transmitted the inquiry.

The electronic receipt management server 4 also receives electronic accumulated receipt information from the electronic receipt server 3 through the network N3. The electronic receipt management server 4 stores and manages the received electronic accumulated receipt information in an electronic accumulated receipt information region 43b3 of an electronic calculation receipt management section 43b, which is contained in the database DB (see FIG. 7). The electronic receipt management server 4 stores a store code of a store, as a portion of the transmitted electronic accumulated receipt information. In the embodiment, the store code has an equivalent function to an SRID. If the store code is specified, electronic accumulated receipt information which is specified by the store code may be transmitted to a store server 2 of a store which is specified by the specified store code.

If an inquiry in which a store code for specifying a store is designated is received from the store server 2 which is connected through the network N5, the electronic receipt management server 4 extracts electronic accumulated receipt information corresponding to the designated store code from the database DB, and transmits the extracted electronic accumulated receipt information to the store server 2 of the corresponding store.

The portable terminal 7 is a terminal apparatus which is carried and used by a user (customer) of the electronic receipt system, such as a smart phone, a mobile phone, a personal digital assistant (PDA), and a tablet computer, for example. In the portable terminal 7, an application for viewing various kinds of information provided over the network N5, such as a web browser, is installed.

The portable terminal 7 performs membership registration to the electronic receipt system by accessing electronic receipt management server 4 through the network N4. The network N4 is the Internet or various public networks.

In the electronic receipt system, membership registration of a customer for receiving electronic receipt information with the portable terminal 7 can be performed through the following procedures, for example. A customer transmits a blank mail from the portable terminal 7 to the electronic receipt management server 4 through the network N4. The electronic receipt management server 4 transmits a Uniform Resource Locator (URL) of a web page for membership registration to the portable terminal 7 using a mail address of the received mail. The customer accesses the URL of the web page for membership registration through the portable terminal 7 and causes an input screen to be displayed. The input screen is a screen to input necessary items (name, transmission destination information, and the like) for membership registration. After the customer completes to input necessary items, the electronic receipt management server 4 performs membership registration on the membership master. Then, the electronic receipt management server 4 delivers a membership registration completion mail including a membership code (customer code) and a (tentative) password to the portable terminal 7. Accordingly, the membership registration is completed.

The portable terminal 7 receives a notification indicating that the electronic receipt management server 4 may transmit electronic receipt information from the electronic receipt management server 4 through the network N4 after payment (transaction) processing is performed at the POS terminal 1. When a member operates the portable terminal 7 to transmit an inquiry of electronic receipt information to the electronic receipt management server 4 through the network N4, electronic receipt information and additional information of the member are transmitted from the electronic receipt management server 4. When the portable terminal 7 receives the received electronic receipt information and additional information, the portable terminal 7 displays the received electronic receipt information and additional information.

In the electronic receipt system having a related configuration, merchandise sales data processing is performed in the POS terminal 1 of the store P1, and electronic receipt information indicating content of a purchase transaction (payment), which is generated through the merchandise sales data processing, is transmitted to the electronic receipt management server 4 through the electronic receipt server 3. Then, the electronic receipt information is uploaded to the web. The portable terminal 7 having an installed web browser can designate a Uniform Resource Locator (URL), and may download the receipt information uploaded to the web to the portable terminal 7, and the user can view the downloaded receipt information with the web browser. An application for viewing receipt information may be installed on the portable terminal 7, and viewing may be performed.

The merchandise sales data processing is performed in the POS terminal 1 of the store P1. Electronic accumulated receipt information indicating content of one or more purchase transactions (payment) which is generated through the merchandise sales data processing during a predetermined period of time is transmitted to the electronic receipt management server 4 through the electronic receipt server 3, and the transmitted electronic accumulated receipt information is uploaded to the web. Accordingly, when the store server 2 to which a web browser is installed designates a Uniform Resource Locator (URL) of the webpage, the store server 2 may download the electronic accumulated receipt information, and the user of the store server 2 may view the downloaded electronic accumulated receipt information with the web browser. An application for viewing electronic accumulated receipt information may be installed on the store server 2, and viewing may be performed.

The store server 2 is also connected to a server 8, which is installed in an external security company P8, through a network N6. A security guard of the security company P8 conveys the sales proceeds of the store P1 to a bank or the like. The server 8 manages amount of the sales proceeds which are conveyed from the store P1, based on the received electronic accumulated receipt information. The store server 2 transmits the electronic accumulated receipt information of the store P1 to the server 8 of the security company P8 through the network N6. The security company P8 determines whether or not the received electronic accumulated receipt information coincides with the amount of the sales proceeds and confirms that the sales proceeds are properly conveyed. The server 8 may receive the electronic accumulated receipt information from the electronic receipt management server 4 through a network N7, and perform the management based on the received electronic accumulated receipt information and the amount of the transferred proceeds.

Then, hardware configuration of main apparatuses in the electronic receipt system according to the embodiment will be described with reference to FIGS. 2 to 9.

First, the POS terminal 1, which is the merchandise sales data processing apparatus, will be described. FIG. 2 is a block diagram of the POS terminal 1. As illustrated in FIG. 2, the POS terminal 1 includes a control unit 11 which generally controls various computations or each unit of the POS terminal 1. The control unit 11 includes a central processing unit (CPU), a read only memory (ROM), a random access memory (RAM) 11a, a real time clock (RTC) unit, and the like. The ROM stores various programs or data. The RAM 11a stores various programs temporarily and stores various data so as to be rewritable. The RTC unit indicates the current date and time.

The control unit 11 is connected to an operation unit 12, a printing unit 13, a display unit 14, a code reader unit 15, a communication I/F 16, and a storage unit 17, through a bus 18.

The operation unit 12 has various operation keys in order for an operator to perform an operation and an input. As the operation keys, a numeric key for inputting a numerical value, a cursor key or a selection and determination key for selecting a predetermined item, a settlement key 121, a calculation key 122, a check key 123, and the like are provided.

The settlement key 121 is a key for executing settlement processing of one purchase transaction and ending the purchase transaction. The calculation key 122 is a key for instructing generation of accumulated receipt information, which is accumulation of printing information in the non-structured format obtained by classifying sales information of the tenant T (see FIG. 3) for a predetermined period of time (for example, a day) before the calculation key 122 is operated, in accordance with one or more categories (for example, sectors, classes, payment types, time zones, and the like) and accumulating the classified sales information. The calculation key 122 is a key for instructing generation of electronic accumulated receipt information obtained by converting a format of the generated accumulated receipt information into the structured format. The calculation key 122 is a key for causing the printing unit 13 to print the generated accumulated receipt information on a receipt sheet and instructing an issue as a calculation receipt. After the electronic accumulated receipt information is generated or the calculation receipt is issued, sales information which is stored in a sales information storage region 11a3 (see FIG. 3) is deleted.

The check key 123 instructs generation of a check sheet obtained by classifying sales information of the tenant T (see FIG. 3) for a predetermined period of time before the check key 123 is operated in accordance with one or more categories (for example, sectors, classes, payment types, time zones, and the like) and accumulating the classified sales information. The check key 123 causes the printing unit 13 to print the generated check sheet information on a receipt sheet and instructs an issue as the check sheet. After the check sheet is issued, the sales information which is stored in the sales information storage region 11a3 (see FIG. 3) is not deleted.

The printing unit 13 is configured as a printer device for printing a receipt, a journal, a calculation receipt, a check sheet, and the like. The printing unit 13 prints information such as merchandise information of purchased merchandise, settlement information obtained through the settlement processing, calculation information, and check information on a roll sheet which is transferred by a thermal head having a heat medium, for example. Then, the printing unit 13 issues the receipt, the journal, the calculation receipt, the check sheet, and the like by cutting the sheet out.

The display unit 14 is a liquid crystal display, for example. The display unit 14 displays various kinds of information regarding the name and a price of merchandise registered for sales, a total price, and an amount of change in one purchase transaction in which settlement is declared, and the like. The display unit 14 displays various kinds of information related to issue processing of a calculation receipt, generation processing and transmission processing of electronic accumulated receipt information, issue processing of a check sheet. The display unit 14 includes a display 14a for an operator, which displays various kinds of information for a cashier and a display 14b for a customer, which displays various kinds of information for a customer. The display unit 14 may have a configuration of a touch panel. In this case, the touch panel functions as the operation unit 12.

The code reader unit 15 is a scanner device for optically reading a code symbol, such as a bar code and a two-dimensional code, for example. The code reader unit 15 reads, for example, a code symbol which is attached to merchandise or a code symbol which is displayed on a display unit of the portable terminal 7, and the like. The control unit 11 receives information contained in the read code symbol. The code symbol which is attached to merchandise contains a merchandise code and the like for specifying the merchandise. The code symbol which is displayed in the portable terminal 7 contains an SRID, a membership code, or the like for specifying the portable terminal 7 or a customer carrying the portable terminal 7. The SRID or the membership code may be stored magnetically or electrically in the portable terminal 7. In this case, a dedicated reading apparatus may read the stored SRID or membership code. The control unit 11 receives the read SRID or membership code.

The control unit 11 is connected to the communication I/F (interface) 16 through the bus 18, and to the network N2 through the communication I/F.

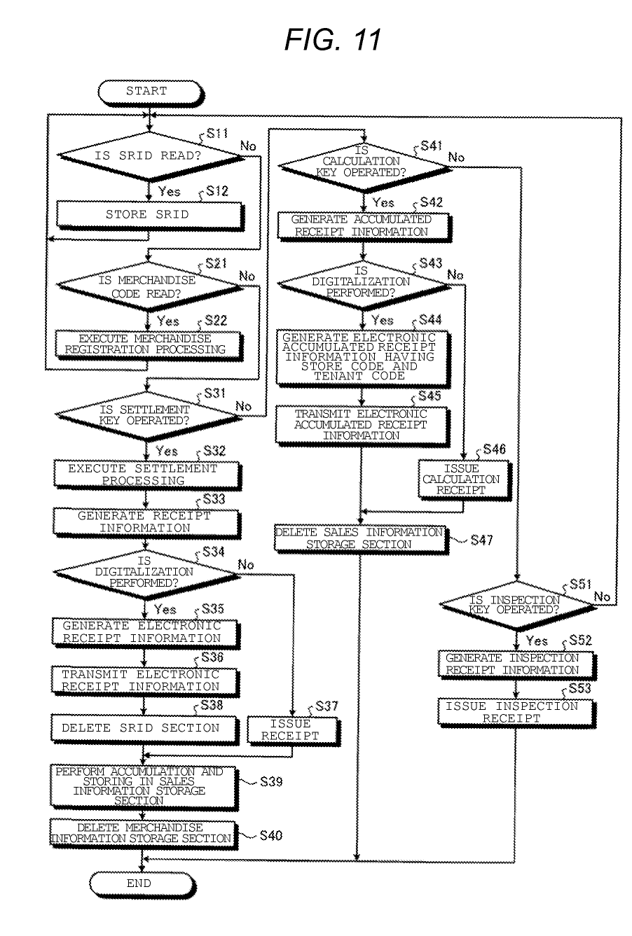

The control unit 11 is also connected to the storage unit 17 through the bus 18. The storage unit 17 is an auxiliary storage device such as a hard disk drive (HDD) and a solid state drive (SSD), for example. The storage unit 17 stores a control program 17a for performing various POS businesses including the merchandise sales data processing, the calculation processing, and the check processing. The control unit 11 executes the control program 17a to carry out the merchandise sales data processing or processing relating to receipt information (see FIG. 11). The storage unit 17 stores various data files relating to the merchandise sales data processing, such as a merchandise data file. The merchandise data file stores merchandise data of a merchandise name, a merchandise code, a unit price, and the like of the merchandise. The control unit 11 executes the control program 17a to carry out the calculation processing and the check processing (see FIG. 11).

The storage unit 17 stores an electronic receipt generation program 17b for generating electronic receipt information from receipt information. The control unit 11 executes the electronic receipt generation program 17b to convert receipt information of the non-structured format into electronic receipt information of the structured format in accordance with a conversion rule described in a receipt information schema (not illustrated). In such a manner, the control unit 11 generates electronic receipt information from receipt information (see FIG. 11).

The storage unit 17 stores a POS number for identifying the own POS terminal 1, a company code (identification code of a company which operates a store), a business type and business category code, the store code which is store information specifying the store P1, and the like. The business type and business category code is used to classify a business type and a business category of the store into a convenience store, a supermarket, a department store, a pharmacy, a restaurant, an eatery, and the like (classification code). A different store code is assigned for each store such that each store is enabled to be specified among stores which are operated by the same company. Such a business type and business category may be changed in accordance with preference of a user. The company code (identification code of a company which operates the store), and the business type and business category code may be also registered in the electronic receipt server 3. The POS terminal 1 stores the store code.

Next, a memory map of the RAM 11a in the control unit 11 of the POS terminal 1 will be described. In FIG. 3, the RAM 11a includes a SRID storage region 11a1, a merchandise information storage region 11a2, and the sales information storage region 11a3.

The SRID storage region 11a1 stores an SRID or a membership code which is input from the code reader unit 15. The merchandise information storage region 11a2 stores merchandise information (merchandise code, merchandise name, unit price, attribute information, and the like) which is read from a merchandise master (not illustrated), using a merchandise code which is input from the code reader unit 15. The sales information storage region 11a3 stores sales information, which is accumulation of merchandise information, settlement information, and the like of merchandise for which the settlement processing has been performed. The sales information storage region 11a3 stores sales information during the predetermined period of time before the calculation key 122 is operated. If the calculation key 122 is operated, content stored in the sales information storage region 11a3 are deleted.

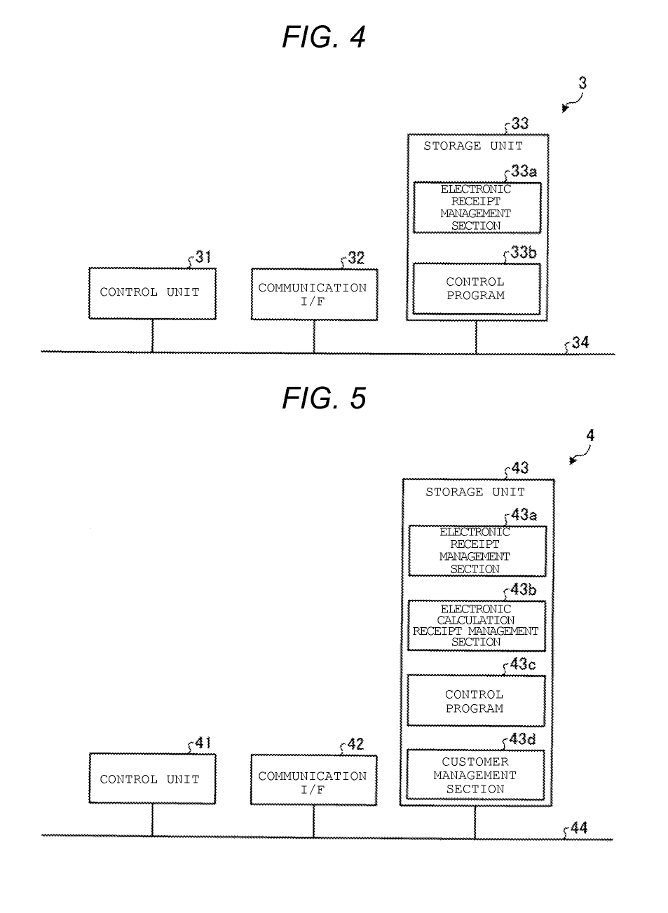

Next, hardware configuration of the electronic receipt server 3 functioning as the receipt management server for company will be described using a block diagram of FIG. 4. In FIG. 4, the electronic receipt server 3 includes a control unit 31 which generally controls various computations or each unit of the electronic receipt server 3. The control unit 31 includes a CPU, a ROM, a RAM, a RTC unit, and the like. The ROM stores various programs or data. The RAM stores various programs temporarily and stores various data so as to be rewritable. The RTC unit indicates the current date and time.

The control unit 31 is configured to be connected to the network N2 or the network N3 through a communication I/F 32 which is connected to a bus 34. The control unit 31 is connected to a storage unit 33 through the bus 34.

The storage unit 33 stores electronic receipt information for a company which operates one or more stores, in an electronic receipt management section 33a. The electronic receipt information includes the company code (identification code of a company which operates a store), the business type and business category code, the store code, one or more membership codes of shoppers, one or more POS numbers of the POS terminals 1, one or more receipt numbers, merchandise sales data, and the like. The storage unit 33 stores a control program 33b for managing the electronic receipt information in the electronic receipt management section 33a.

Next, hardware configuration of the electronic receipt management server 4 functioning as the receipt management server for customer will be described using a block diagram of FIG. 5. In FIG. 5, the electronic receipt management server 4 includes a control unit 41 which generally controls various computations or each unit of the electronic receipt management server 4. The control unit 41 includes a CPU, a ROM, a RAM, a RTC unit, and the like. The ROM stores various programs or data. The RAM stores various programs temporarily and stores various data so as to be rewritable. The RTC unit indicates the current date and time.

The control unit 41 is configured to be connected to the network N3, the network N4, and the network N5 through a communication I/F 42 which is connected to a bus 44. The control unit 41 is connected to a storage unit 43 through the bus 44.

The storage unit 43 includes an electronic receipt management section 43a, an electronic calculation receipt management section 43b, and a customer management section 43d. Further, the storage unit 43 stores a control program 43c. In the electronic receipt management area 43a, electronic receipt information of multiple companies each of which operates one or more stores is managed with respect to each member, and the electronic receipt information is received from the electronic receipt server 3. In the electronic calculation receipt management section 43b, electronic accumulated receipt information is stored with respect to each tenant T, and the electronic accumulated receipt information is received from the electronic receipt server 3 and is generated by the POS terminal 1 of each tenant T executing the calculation processing. The POS terminal 1 executes the calculation processing in each tenant T. The electronic accumulated receipt information includes the store code of the store P1 in which the tenant T is operated.

The electronic receipt information includes a membership code, a company code (identification code of a company which operates a store), a tenant code, a store code, a POS number of the POS terminal 1, a receipt number, merchandise sales data (including date and time data), and the like. Accordingly, for example, a manufacturer of consumer goods may obtain purchase certification information of purchased merchandise, which is associated with the manufacturer, from the electronic receipt information in accordance with a specific condition (for example, limitation of a specific company which operates a store, limitation of a specific district, limitation of a specific time, and the like). The electronic receipt information includes an SRID for specifying the portable terminal 7 to which the electronic receipt information is to be transmitted.

The electronic accumulated receipt information includes a tenant code specifying the tenant T in which the calculation processing is executed, a company number of a company which operates the tenant T, sales information, one or more POS numbers, one or more receipt numbers, a calculator number specifying a person which executes the calculation processing, date information regarding when the calculation processing is executed, a store code specifying a store in which the tenant T is operated, and the like.

The storage unit 43 stores the control program 43c for managing the electronic receipt management section 43a, the electronic calculation receipt management section 43b, and the like. The storage unit 43 has the customer management section 43d for managing information about customers carrying the portable terminals 7. The customer management section 43d stores various kinds of customer information corresponding to a customer ID specifying a customer, and the terminal code (SRID) specifying the portable terminal 7 carried by the customer. The customer ID and the SRID are correlated with each other and stored.

Next, the electronic receipt management section 43a will be described with reference to FIG. 6. In FIG. 6, the electronic receipt management section 43a stores electronic receipt information generated in a purchase transaction, with respect to each transaction. The electronic receipt management area 43a includes a SRID region 43a1, a tenant code region 43a2, a store code region 43a3, and an electronic receipt information region 43a4. The SRID region 43a1 stores an electronic receipt ID (referred to as “SRID” below) which is a terminal code for specifying the portable terminal 7 which receives an electronic receipt. The SRID region 43a1 stores an SRID which is read by the code reader unit 15 of the POS terminal 1. The tenant code region 43a2 stores the tenant code specifying the tenant T in which the POS terminal 1 generating electronic receipt information is located, with respect to each SRID. The store code region 43a3 stores the store code specifying the store P1 in which the tenant T is located, with respect to each SRID. The electronic receipt information region 43a4 stores electronic receipt information obtained by converting receipt information of one purchase transaction in an electronic receipt form, with respect to each SRID. In the embodiment, the electronic receipt information includes an SRID which is stored in the SRID region 43a1, a tenant code which is stored in the tenant code region 43a2, a store code which is stored in the store code region 43a3, electronic receipt information which is stored in the electronic receipt information region 43a4. FIG. 6 illustrates electronic receipt information in a certain purchase transaction.

Next, the electronic calculation receipt management section 43b storing electronic accumulated receipt information which is generated by the POS terminal 1 will be described with reference to FIG. 7. In FIG. 7, the electronic calculation receipt management section 43b includes a tenant code region 43b1, a store code region 43b2, and an electronic accumulated receipt information region 43b3. The tenant code section 43b1 stores a tenant code specifying the tenant T in which the POS terminal 1 generating electronic accumulated receipt information is located. The store code region 43b2 stores the store code specifying the store P1 in association with a tenant code of the tenant T in the store P1. The electronic accumulated receipt information region 43b3 stores the electronic accumulated receipt information in association with a tenant code. The electronic accumulated receipt information is structured and is obtained by performing calculation processing on receipt information of one or more purchase transactions performed during a predetermined period of time in accordance with an operation of the calculation key 122, and the receipt information is stored in the sales information storage section 11a3. In the embodiment, the electronic accumulated receipt information includes a tenant code stored in the tenant code region 43b1, a store code stored in the store code region 43b2, and electronic accumulated receipt information stored in the electronic accumulated receipt information region 43b3. FIG. 7 illustrates electronic accumulated receipt information obtained by performing the calculation processing in a certain tenant T.

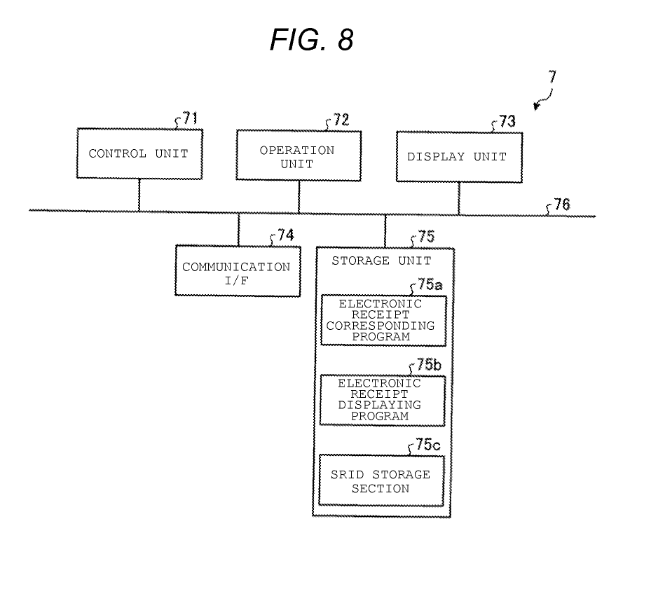

Next, the portable terminal 7 will be described using a block diagram of FIG. 8. In FIG. 8, the portable terminal 7 includes a control unit 71 which generally controls various computations or each unit of the portable terminal 7. The control unit 71 is a computer which includes a CPU, a ROM, a RAM, a RTC unit, and the like. The ROM stores various programs or data. The RAM stores various programs temporarily and stores various data so as to be rewritable. The RTC unit indicates the current date and time.

An operation unit 72 is connected to a display unit 73 through a bus 76. The operation unit 72 has various operation keys or a pointing device for an operator (customer) performing an operation and an input. The display unit 73 is a liquid crystal display, for example. The display unit 73 displays various kinds of information including electronic receipt information. The display unit 73 may have a configuration of a touch panel. In this case, the touch panel functions as the operation unit 72.

The control unit 71 is connected to a communication I/F 74 through the bus 76, and to the network N5 through the communication I/F 74.

The control unit 71 is connected to a storage unit 75 through the bus 76. The storage unit 75 includes an electronic receipt corresponding program 75a, an electronic receipt displaying program 75b, and an SRID storage section 75c in addition to a web browser. The web browser is used to display various kinds of information (contents) which are uploaded to the web. The electronic receipt corresponding program 75a is executed to receive electronic receipt information from the electronic receipt management server 4. The electronic receipt displaying program 75b is executed to display the received receipt information. The SRID storage section 75c stores an SRID specifying the portable terminal 7 to which electronic receipt information is transmitted. The SRID stored in the SRID storage section 75c is displayed on a display unit 73 by a code symbol. The POS terminal 1 reads a code symbol displayed on the display unit 73 using the code reader unit 15, and recognizes the SRID.

The SRID is displayed as a code symbol and may be read magnetically or electrically by the POS terminal 1. Instead of the portable terminal 7, the SRID may be read from a membership card or the like, for example. A customer ID specifying a customer may be read instead of the SRID. In this case, the SRID which is stored in the corresponding electronic receipt management server 4 is obtained based on the read customer ID.

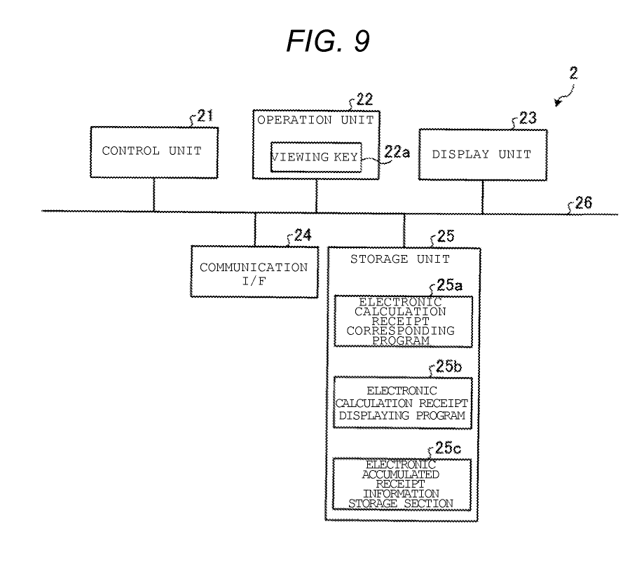

Next, the store server 2 will be described using a block diagram of FIG. 9. In FIG. 9, the store server 2 includes a control unit 21 which generally controls various computations or each unit of the store server 2. The control unit 21 includes a CPU, a ROM, a RAM, a RTC unit, and the like. The ROM stores various programs or data. The RAM stores various programs temporarily and stores various data so as to be rewritable. The RTC unit indicates the current date and time.

An operation unit 22 is connected to a display unit 23 through a bus 26. The operation unit 22 has various operation keys or a pointing device for an operator (customer) performing an operation and an input. The operation unit 22 includes a viewing key 22a. The viewing key 22a is operated when a viewing request is transmitted to the electronic receipt management server 4, such that the store server 2 collects accumulated receipt information of each tenant T operated in the store P1, from the electronic receipt management server 4.

The display unit 23 is a liquid crystal display, for example, and displays various kinds of information including electronic accumulated receipt information. The display unit 23 may have a configuration of a touch panel. In this case, the touch panel functions as the operation unit 22.

The control unit 21 is connected to a communication I/F 24 through the bus 26, and to the network N5 and the network N6 through the communication I/F 24.

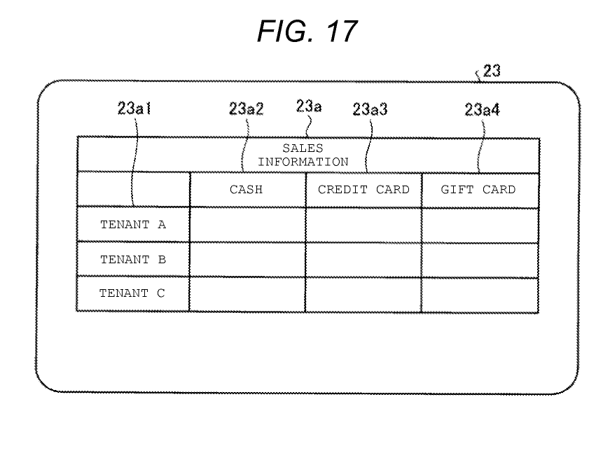

The control unit 21 is also connected to a storage unit 25 through the bus 26. The storage unit 25 includes an electronic calculation receipt corresponding program 25a, an electronic calculation receipt displaying program. 25b, and an electronic accumulated receipt information storage section 25c in addition to a web browser for displaying various kinds of information (contents) which are uploaded to the web. The electronic calculation receipt corresponding program 25a is executed to receive electronic accumulated receipt information from the electronic receipt management server 4. The electronic calculation receipt displaying program 25b is executed to display the received electronic accumulated receipt information. The electronic accumulated receipt information storage section 25c stores electronic accumulated receipt information received from the electronic receipt management server 4. In the embodiment, the electronic accumulated receipt information which is received from the store server 2 is information processed in the electronic receipt management server 4, as illustrated in FIG. 17.

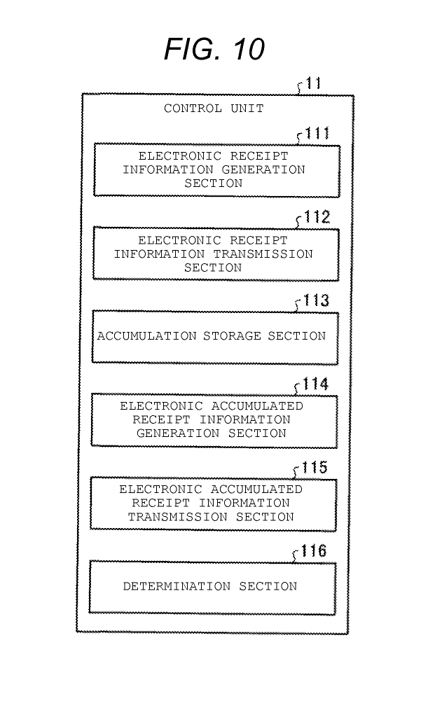

Next, control processing executed by each unit in the embodiment will be described with reference to FIGS. 10 to 17.

First, the control processing by the POS terminal 11 will be described with reference to a functional block diagram illustrated in FIG. 10 and a flowchart illustrated in FIG. 11. The control unit 11 of the POS terminal 1 executes the control program 17a and the electronic receipt generation program 17b, to perform the control processing.

As illustrated in FIG. 10, when the control program 17a and the electronic receipt generation program 17b are executed in the POS terminal 1, following modules are generated: an electronic receipt information generation section 111; an electronic receipt information transmission section 112; an accumulation storage section 113; an electronic accumulated receipt information generation section 114; an electronic accumulated receipt information transmission section 115; and a determination section 116. As actual hardware, the CPU of the control unit 11 reads and executes the control program 17a and the electronic receipt generation program 17b from the storage unit 17, and as a result, these sections 111-116 are generated.

The electronic receipt information generation section 111 has a function to generate electronic receipt information indicating content of a purchase transaction obtained by digitalizing the content.

The electronic receipt information transmission section 112 has a function to transmit the generated electronic receipt information to an external electronic receipt management server using a communication line.

The accumulation storage section 113 has a function to store accumulation information obtained by accumulating transaction information generated during a predetermined period of time.

The electronic accumulated receipt information generation section 114 has a function to generate electronic accumulated receipt information, indicating content of accumulation information obtained by digitalizing the accumulation information.

The electronic accumulated receipt information transmission section 115 has a function to transmit the generated electronic accumulated receipt information to the electronic receipt management server 4 using a communication line.

The determination section 116 has a function to determine whether or not store information specifying a store is included in the accumulated receipt information.

Next, the control processing performed by the control unit 11 of the POS terminal 1 in accordance with the control program 17a and the electronic receipt generation program 17b will be described using the flowchart illustrated in FIG. 11.

In FIG. 11, the control unit 11 of the POS terminal 1 determines whether or not an SRID which is stored in the portable terminal 7 is read by the code reader unit 15 (Step S11). When it is determined that the SRID is read (Yes in Step S11), the control unit 11 stores the read SRID in the SRID storage section 11a1 in the RAM 11a of the control unit 11 (Step S12). Then, the control unit 11 returns to Step S11 and waits.

When it is determined that the SRID stored in the portable terminal 7 is not read (No in Step S11), the control unit 11 determines whether or not a code symbol attached to merchandise is read by the code reader unit 15 (Step S21). When it is determined that the merchandise code is read (Yes in Step S21), the control unit 11 executes merchandise registration processing based on the read merchandise code (Step S22). Then, the control unit 11 returns to Step S11 and waits.

In the merchandise registration processing, merchandise master (not illustrated) which is stored in the storage unit is searched based on the read merchandise code, and merchandise information (merchandise code, merchandise name, unit price, attribute information, and the like) which is stored in the merchandise master corresponding to the read merchandise code is read out and is stored in the merchandise information storage section 11a2 in the RAM 11a.

When it is determined that the merchandise code is not read (No in Step S21), the control unit 11 determines whether or not the settlement key 121 is operated (Step S31). When it is determined that the settlement key 121 is operated (Yes in Step S31), the control unit 11 executes the settlement processing of the transaction (Step S32). The settlement processing means processing of calculating a total price based on merchandise information which is stored in a merchandise information portion, displaying the calculated total price on the display unit 14, and ending the transaction upon payment in one of various payment methods. The control unit 11 generates receipt information in the non-structured format based on settlement information of the transaction, in order to print the receipt information on a receipt sheet (Step S33). When the SRID is stored in the SRID storage section 75c, receipt information in the non-structured format, including the SRID, is generated in Step S33.

The control unit 11 determines whether or not electronic receipt information is to be generated, based on the receipt information (Step S34). When the SRID is included in the generated receipt information, the control unit 11 determines that the electronic receipt information is generated.

When it is determined that the electronic receipt information is generated (Yes in Step S34), the control unit (electronic receipt information generation section 111) executes the electronic receipt generation program 17b to convert the receipt information in the non-structured format, which is generated in Step S33, to electronic receipt information in the structured format (Step S35). The generated electronic receipt information includes the SRID, the tenant code, and the store code specifying the store P1 in which the POS terminal 1 is located, as illustrated in FIG. 6. The control unit 11 (electronic receipt information transmission section 112) transmits the generated electronic receipt information including the SRID and the store code to the electronic receipt server 3 (Step S36).

The control unit 11 deletes the SRID stored in the SRID storage section 11a1 (Step S38). The control unit 11 (accumulation storage section 113) accumulates and stores merchandise information stored in the merchandise information storage section 11a2, in the sales information storage section 11a3 (Step S39). The control unit 11 deletes the merchandise information stored in the merchandise information storage section 11a2 (Step S40). Then, the control unit 11 ends processing.

When it is determined that the electronic receipt information is not generated based on the receipt information (that is, the SRID is not included in the receipt information generated in Step S33) (No in Step S34), the control unit 11 controls the printing unit 13 to perform printing based on the receipt information which is generated in Step S33, and to issue a paper receipt (Step S37). Then, the control unit 11 executes processes in Steps S39 and S40, and ends processing.

In Step S31, when it is determined that the settlement key 121 is not operated (No in Step S31), the control unit 11 determines whether or not the calculation key 122 is operated (Step S41). When it is determined that the calculation key 122 is operated (Yes in Step S41), the control unit 11 generates accumulated receipt information in the non-structured format based on sales information stored in the sales information storage section 11a3 (Step S42). The generated accumulated receipt information has the same structure as the receipt information generated in Step S33.

When electronic accumulated receipt information is generated based on the accumulated receipt information, the control unit 11 includes a tenant code of a tenant in which the POS terminal 1 generating the accumulated receipt information is located, in a process of Step S42. The control unit 11 also includes a store code of a store in which the tenant is operated, in the process of Step S42. The control unit 11 generates accumulated receipt information including information obtained by performing classification the sales information which is stored in the sales information storage section 11a3, with respect to payment methods. For example, the accumulated receipt information includes sales information classified by types of payment which includes cash payment, credit payment, gift card payment, and the like.

The control unit 11 (determination section 116) determines whether or not the generated accumulated receipt information is digitalized, based on whether or not the store code is included in the generated accumulated receipt information (Step S43). The control unit 11 determines that the generated accumulated receipt information is digitalized, when the store code is included in the generated accumulated receipt information. The control unit 11 determines that the generated accumulated receipt information is not digitalized, when the store code is not included in the generated accumulated receipt information.

When it is determined that the accumulated receipt information is digitalized (Yes in Step S43), the control unit (electronic accumulated receipt information generation section 114) generates electronic accumulated receipt information in the structured format based on the generated accumulated receipt information (Step S44). The electronic accumulated receipt information has a structure of the same format as the electronic receipt information generated in Step S35. The electronic accumulated receipt information includes information obtained by digitalizing the sales information classified by types of payment, including cash payment, credit payment, gift card payment, and the like. The electronic accumulated receipt information includes the tenant code, the store code, and the electronic accumulated receipt information, as illustrate in FIG. 7. The control unit 11 (electronic accumulated receipt information transmission section 115) transmits the generated electronic accumulated receipt information to the electronic receipt server 3 (Step S45). The control unit 11 deletes sales information stored in the sales information storage section 11a3 (Step S47). Then, the control unit 11 ends processing.

The electronic accumulated receipt information generated in Step S44 is preferred to have a time stamp which indicates date and time when the information is generated, or an electronic signature, by a third party organization, so as to prevent falsification. For this reason, the electronic accumulated receipt information may be delivered from the POS terminal 1 to the third party organization, have a time stamp or electronic signature provided, and then may be transmitted to the electronic receipt server 3.

In Step S43, when it is determined that the accumulated receipt information is not digitalized (No in Step S43), the control unit 11 transmits the generated accumulated receipt information as printing information to the printing unit 13. The printing unit 13 prints the received accumulated receipt information on a receipt sheet. The control unit 11 cuts the receipt sheet on which the printing unit 13 performs printing and issues the cut receipt sheet as a calculation receipt (Step S46). Then, the control unit 11 executes Step S47 and ends processing.

In Step S41, when it is determined that the calculation key 122 is not operated (No in Step S41), the control unit 11 determines whether or not the check key 123 is operated (Step S51). When it is determined that the check key 123 is operated (Yes in Step S51), the control unit 11 generates check sheet information in the non-structured format based on sales information stored in the sales information storage section 11a3 (Step S52). The check sheet information has the same structure as the accumulated receipt information generated in Step S42.

The control unit 11 transmits the generated check sheet information as printing information to the printing unit 13. The printing unit 13 prints the check sheet information on the receipt sheet. The control unit 11 cuts the receipt sheet on which the printing unit 13 performs printing and issues the cut receipt sheet as a check sheet (Step S53). Then, the control unit 11 ends processing. The control unit 11 does not delete the sales information which is stored in the sales information storage section 11a3 even though the check sheet is issued in Step S53. In Step S51, when it is determined that the check key 123 is not operated (No in Step S51), the control unit 11 returns to Step S11 and waits.

The POS terminal 1 according to the embodiment generates electronic accumulated receipt information in a predetermined structured format, from accumulated receipt information in the non-structured format, which is generated by the POS terminal 1, and the POS terminal 1 transmits the generated electronic accumulated receipt information to the electronic receipt management server 4. In this manner, it is possible to report sales information of a tenant to a store in which the tenant is operated, using a structure similar to a structure of an electronic receipt which is transmitted to the portable terminal 7. Accordingly, an expensive infrastructure which, for example, connects each tenant T and the store server 2 in the store P1 over a communication line, may not be needed.

According to the POS terminal 1 in the embodiment, since electronic accumulated receipt information is generated when a store code specifying a store is included in accumulated receipt information, it is possible to generate the electronic accumulated receipt information including the store code.

According to the POS terminal 1 in the embodiment, since sales information classified by types of payment can be generated when the electronic accumulated receipt information is generated, it is possible to transmit sales information with respect to each payment type.

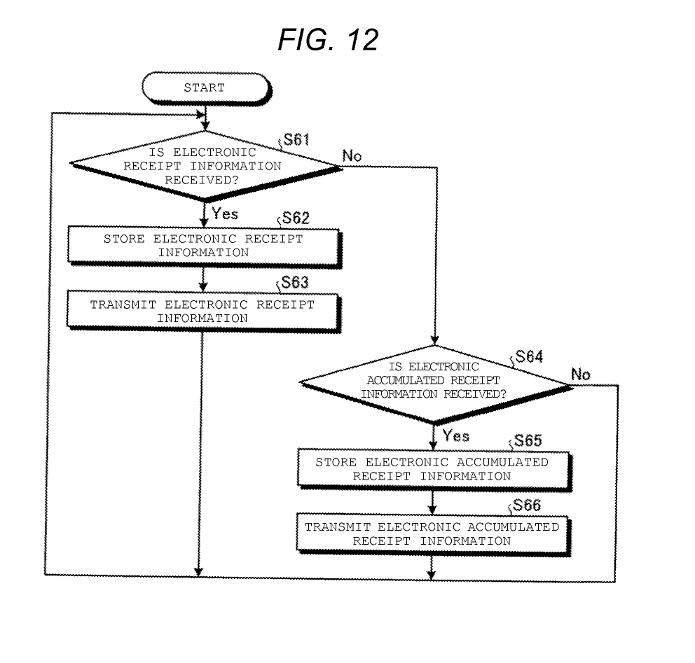

Next, a flow of electronic receipt management processing will be described with reference to a flowchart illustrated in FIG. 12. The control unit 31 of the electronic receipt server 3 executes the control program 33b to perform the electronic receipt management processing.

The control unit 31 of the electronic receipt server 3 determines whether or not the electronic receipt information, which is transmitted from the POS terminal 1 in Step S36, is received through the communication I/F 32 (Step S61). When it is determined that the electronic receipt information is received (Yes in Step S61), the control unit 31 causes the received electronic receipt information to be stored in the electronic receipt management section 33a of the storage unit 33 as electronic receipt information of the corresponding company (Step S62). The control unit 31 transmits the electronic receipt information stored in Step S62 to the electronic receipt management server 4 (Step S63), and returns to Step S61.

When it is determined that the electronic receipt information is not received (No in Step S61), the control unit 31 determines whether or not the electronic accumulated receipt information, which is transmitted from the POS terminal 1 in Step S45, is received through the communication I/F 32 (Step S64). When it is determined that the electronic receipt information is received (Yes in Step S64), the control unit causes the received electronic accumulated receipt information to be stored in the electronic receipt management section 33a of the storage unit 33 as electronic accumulated receipt information (Step S65). The control unit 31 transmits the electronic accumulated receipt information including the store code which is stored in Step S65, to the electronic receipt management server 4 (Step S66), and returns to Step S61. In Step S64, when it is determined that the electronic accumulated receipt information is not received (No in Step S64), the control unit 31 returns to Step S61 and waits.

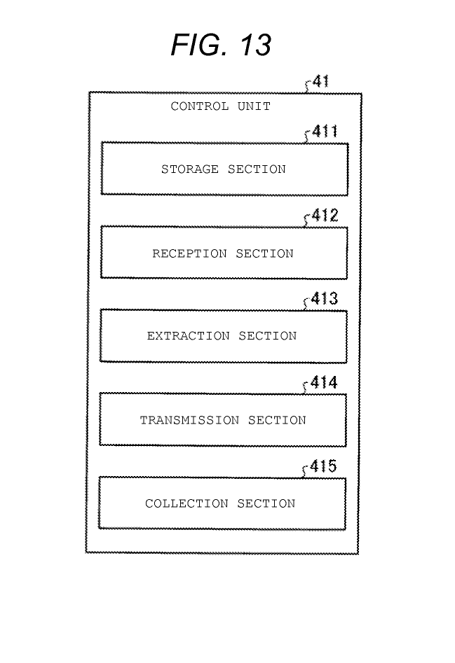

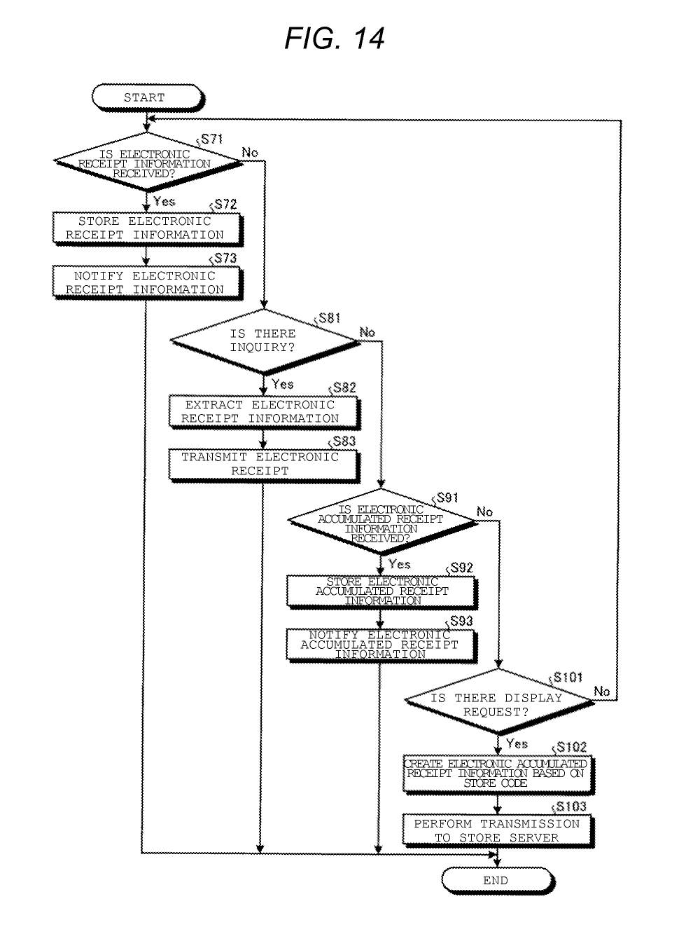

Next, electronic receipt control processing will be described with reference to a functional block diagram illustrated in FIG. 13 and a flowchart illustrated in FIG. 14. The control unit 41 of the electronic receipt management server 4 executes the control program 43c to perform the electronic receipt control processing.

As illustrated in FIG. 13, when the control program 43c is executed in the electronic receipt management server 4 modules including a storage section 411, a reception section 412, an extraction section 413, a transmission section 414, and a collection section 415 are generated. As actual hardware, the CPU of the control unit 41 reads and executes the control program 43c from the storage unit 43, and as a result the storage section 411, the reception section 412, the extraction section 413, the transmission section 414, and the collection section 415 are generated.

The storage section 411 has a function to receive and store electronic accumulated receipt information, which is generated based on store information specifying a store and accumulation information obtained by accumulating transaction information generated during the predetermined period of time. The store information and accumulation information are received from the merchandise sales data processing apparatus and the transaction information of merchandise is associated with the store information.

The reception section 412 has a function to receive the store information.

The extraction section 413 has a function to extract electronic accumulated receipt information associated with the received store information from the stored electronic accumulated receipt information.

The transmission section 414 has a function to transmit the extracted electronic accumulated receipt information to an external apparatus.

The collection section 415 has a function to collect electronic accumulated receipt information of each payment type in a transaction, based on the extracted electronic accumulated receipt information.

FIG. 14 is a flowchart illustrating control processing carried out by the electronic receipt management server 4. In FIG. 14, the control unit 41 determines whether or not the electronic receipt information is received from the electronic receipt server 3 (Step S71). When it is determined that the electronic receipt information is received (Yes in Step S71), the control unit 41 (storage section 411) causes electronic receipt information including the SRID, the tenant code, and the store code to be stored in the electronic receipt management area 43a (Step S72). The control unit 41 transmits a notification to an address and the like associated with the portable terminal 7 specified by the SRID (Step S73). The address and the like are stored in the customer management area 43d in association with the SRID included in the received electronic receipt information. The notification indicates that the electronic receipt management server 4 receives the electronic receipt information and the electronic receipt information is ready to be downloaded to and displayed on the portable terminal 7. Then, the control unit 41 ends processing.

When it is determined that the electronic receipt information is not received from the electronic receipt server 3 (No in Step S71), the control unit 41 determines whether or not there is an inquiry of electronic receipt information from the portable terminal 7 (Step S81). The inquiry of the electronic receipt information is performed by operating the portable terminal 7 which has received the notification in Step S73.

When it is determined that there is the inquiry of the electronic receipt information (Yes in Step S81), the control unit 41 extracts the electronic receipt information from the electronic receipt management section 43a (Step S82). The control unit 41 transmits the extracted electronic receipt information to the portable terminal 7 specified by the SRID based on the SRID included in the extracted electronic receipt information (Step S83). Then, the control unit 41 ends processing.

When it is determined that there is no inquiry of the electronic receipt information (No in Step S81), the control unit 41 (reception section 412) determines whether or not electronic accumulated receipt information including a store code is received in accordance with the process of Step S66 (Step S91). When it is determined that the electronic accumulated receipt information is received (Yes in Step S91), the control unit 41 stores the electronic accumulated receipt information which is received and includes the tenant code and the store code, in the electronic calculation receipt management section 43b (Step S92). The control unit 41 notifies the store server 2 of a store specified by the store code included in the stored electronic accumulated receipt information that the electronic accumulated receipt information is received (Step S93). Then, the control unit 41 ends processing.

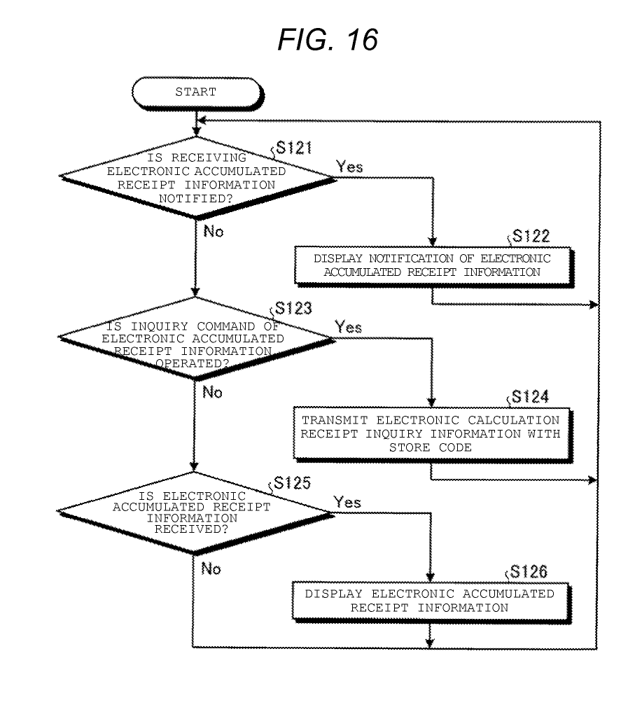

In Step S91, when it is determined that the electronic accumulated receipt information is not received (No in Step S91), the control unit 41 determines whether or not there is a displaying request of the electronic accumulated receipt information which is transmitted from the store server 2 in Step S124 (See FIG. 16) (Step S101). Displaying request information is received along with the store code of a store in which the store server 2 transmitting the displaying request is located. When it is determined that there is the displaying request of the electronic accumulated receipt information (Yes in Step S101), the control unit 41 (extraction section 413) creates electronic accumulated receipt information based on the store code included in the electronic accumulated receipt information (Step S102).

That is, if the displaying request information is received along with the store code from the store server 2, the control unit 41 searches for the electronic calculation receipt management section 43b, and extracts all electronic accumulated receipt information in which the received store code is included in the store code region 43b2, from the electronic accumulated receipt information stored in the electronic accumulated receipt management area 43b. The control unit 41 classifies the extracted electronic accumulated receipt information by the tenant code and the payment type (for example, table format as illustrated in FIG. 17) and collects the classified electronic accumulated receipt information. If the electronic accumulated receipt information received by the electronic receipt management server 4 has a CSV file format, for example, since a plurality of pieces of information is separated by commas, it is easy to classify the electronic accumulated receipt information using the tenant code and the payment type.

Then, the control unit 41 transmits the created electronic accumulated receipt information to the store server 2 of a store corresponding to the received store code (Step S103).

In the embodiment, the classified accumulated receipt information is created in the process of Step S102. Alternatively, the classified electronic accumulated receipt information may be created in advance, for example, at a timing prior to a time when there is the displaying request in the Step S101. In this case, if there is the display request in the Step S101, it is possible to immediately transmit electronic accumulated receipt information created already and classified based on the store code. For this reason, it is possible to reduce a transmission time of the electronic accumulated receipt information and to reduce loads of the classified electronic receipt management server 4 relating to transmission, in the electronic receipt management server 4.

In such an embodiment, the electronic receipt management server 4 receives the electronic accumulated receipt information transmitted by the POS terminal 1 through the electronic receipt server 3. The electronic receipt management server 4 extracts the electronic accumulated receipt information based on a store code, and transmits the extracted electronic accumulated receipt information to the store server 2 using the received store code. The store server 2 obtains sales information of each tenant using the received electronic accumulated receipt information. In this manner, the store server 2 may report the sales information of a tenant from the tenant to the store using a structure similar to the structure of the electronic receipt transmitted to the portable terminal 7. Accordingly, an expensive infrastructure which, for example, connects each tenant T and the store server 2 which is installed in the store P1 over a communication line, is not needed.

In the embodiment, the electronic receipt management server 4 classifies the electronic accumulated receipt information by the payment type of a transaction, collects the classified electronic accumulated receipt information, and transmits the collected electronic accumulated receipt information to the store server 2. Thus, the store server 2 which receives the transmitted electronic accumulated receipt information may display the electronic accumulated receipt information classified as illustrated in FIG. 17, for example.

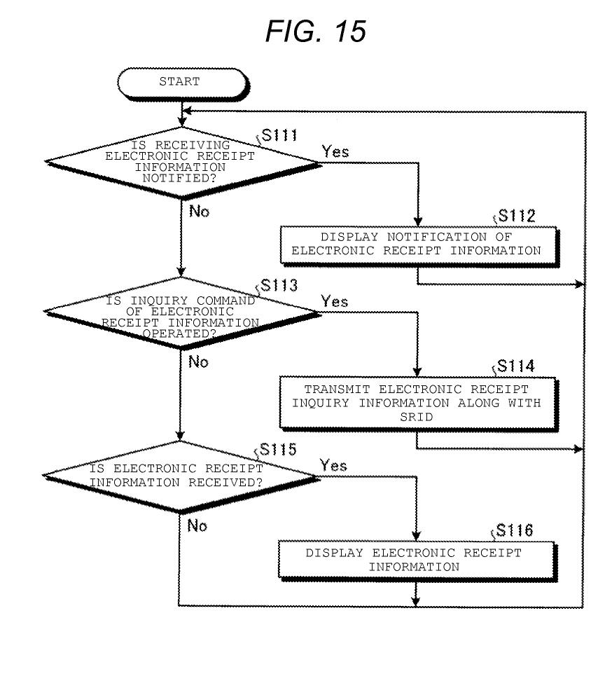

Next, a flow of electronic receipt reception processing and a flow of electronic receipt displaying processing will be described with reference to FIG. 15. The control unit 71 of the portable terminal 7 executes the electronic receipt corresponding program 75a, to perform the electronic receipt reception processing. The control unit 71 also executes the electronic receipt displaying program 75b, to perform the electronic receipt displaying processing.

As illustrated in FIG. 15, the control unit 71 determines whether or not a notification is received from the electronic receipt management server 4 (Step S111). The notification indicates that the electronic receipt information is received from the electronic receipt server 3. When it is determined that the notification is received (Yes in Step S111), the control unit 71 displays a notification indicating reception on the display unit 73 (Step S112). The notification is a message “an electronic receipt of a customer is available”, and the like, for example.

When it is determined that the notification of receiving the electronic receipt information is not received (No in Step S111), the control unit 71 determines whether or not an inquiry command of the electronic receipt information is operated (Step S113). An operator of the portable terminal 7 who checks the notification operates the operation unit 72 in order to transmit an inquiry of the electronic receipt information. When it is determined that the inquiry command is operated (Yes in Step S113), the control unit 71 transmits the inquiry of an electronic receipt along with the SRID which specifies the portable terminal 7 and is stored in the SRID storage section 75c, to the electronic receipt management server 4 (Step S114). The electronic receipt management server 4 which receives the inquiry executes processes of Steps S81 to S83 in FIG. 14 and transmits the electronic receipt information to the portable terminal 7.

When it is determined that the inquiry command of the electronic receipt information is not operated (No in Step S113), the control unit 71 determines whether or not the electronic receipt information is received from the electronic receipt management server 4 (Step S115). When it is determined that the electronic receipt information is received (Yes in Step S115), the control unit 71 displays the received electronic receipt information on the display unit 73 (Step S116). When only the electronic receipt information is received, the control unit 71 displays the electronic receipt information.

Next, flows of electronic calculation receipt reception processing and electronic calculation receipt displaying processing will be described with reference to FIGS. 16 and 17. The control unit 21 of the store server 2 executes the electronic calculation receipt corresponding program 25a, to perform the electronic calculation receipt reception processing. The control unit 21 executes the electronic calculation receipt displaying program 25b, to perform the electronic calculation receipt displaying processing.

As illustrated in FIG. 16, the control unit 21 determines whether or not a notification is received from the electronic receipt management server 4 (Step S121). The notification indicates that electronic accumulated receipt information is received from the electronic receipt server 3. When it is determined that the notification is received (Yes in Step S121), the control unit 21 displays the notification indicating reception on the display unit 23 (Step S122). The notification is a message “accumulated receipt information is received”, and the like, for example.

When it is determined that the notification of receiving the electronic accumulated receipt information is not received (No in Step S121), the control unit 21 determines whether or not an inquiry command of the electronic accumulated receipt information is operated (Step S123). An operator of the store server 2 who checks the notification operates the operation unit 22 in order to receive a response to an inquiry of the electronic accumulated receipt information from the electronic receipt management server 4 at a predetermined timing (for example, a closing time of a store, and the like). When it is determined that the inquiry command is operated (Yes in Step S123), the control unit 21 transmits the inquiry information of an electronic receipt along with the store code specifying a store in which the store server 2 is installed, to the electronic receipt management server 4 (Step S124). The electronic receipt management server 4 which receives the inquiry executes processes of Steps S101 to S103 in FIG. 14 and transmits the electronic receipt information to the store server 2 of the store.

When it is determined that the inquiry command of the electronic receipt information is not operated (No in Step S123), the control unit 21 determines whether or not the electronic accumulated receipt information is received from the electronic receipt management server 4 (Step S125). When it is determined that the electronic accumulated receipt information is received (Yes in Step S125), the control unit displays the received electronic accumulated receipt information on the display unit 23 (Step S126).

FIG. 17 illustrates an example of electronic accumulated receipt information 23a displayed on the display unit 23. In FIG. 17, the electronic accumulated receipt information 23a includes a tenant section 23a1, a cash section 23a2 corresponding to cash payment, which is one of payment types, a credit section 23a3 corresponding to credit card payment, which is another one of the payment types, and a gift card section 23a4 corresponding to gift card payment, which is the other one of the payment types.

In FIG. 17, sales information of transactions paid by cash in the tenant A is displayed on the cash section 23a2 of the tenant A. Similarly, sales information of transactions paid by credit cards in the tenant A is displayed on the credit section 23a3 of the tenant A. Further, sales information of transactions paid by gift cards in the tenant A is displayed on the gift card section 23a4 of the tenant A.

Sales information of transactions paid by cash in the tenant B is displayed on the cash section 23a2 of the tenant B. Similarly, sales information of transactions paid by credit cards in the tenant B is displayed on the credit section 23a3. Further, sales information of transactions paid by gift cards in the tenant B is displayed on the gift card section 23a4.

Sales information of transactions paid by cash in the tenant C is displayed on the cash section 23a2 of the tenant C. Similarly, sales information of transactions paid by credit cards in the tenant C is displayed on the credit section 23a3. Further, sales information of transactions paid by gift cards in the tenant C is displayed on the gift card section 23a4.

The electronic accumulated receipt information received in Step S125 may be transmitted to the server 8 of the security company P8 through the network N6. The security company P8 may collate an amount of sales proceeds which are physically conveyed from the store P1 by the security company P8, with the received electronic accumulated receipt information. Alternatively, the electronic accumulated receipt information may be transmitted from the electronic receipt management server 4 to the server 8 of the security company P8.

In this manner, according to the embodiment, since the display unit 23 of the store server 2 displays electronic accumulated receipt information corresponding to sales information classified by the tenant and the payment type, a manager of the store who checks the display unit 23 of the store server 2 may easily recognize sales information of each tenant during a predetermined period of time. Since the electronic receipt management server 4 creates electronic accumulated receipt information classified in order to display the electronic accumulated receipt information corresponding to sales information by each tenant and each of payment type, on the display unit 23 of the store server 2, a manager of the store who checks the display unit 23 of the store server 2 may easily recognize sales information of each tenant during a predetermined period of time.

In the above embodiment, the electronic accumulated receipt information includes the store code. Alternatively, the electronic accumulated receipt information and the store code may be separate information units, and these two information units may be stored and transmitted in a state of being correlated with each other.

In the above embodiment, the descriptions are made by exemplifying the three tenants T of the tenant A, the tenant B, and the tenant C. However, the number of tenants T may be not particularly limited.

In the embodiment, the electronic receipt management server 4 processes and creates the electronic accumulated receipt information to be displayed in the store server 2 as illustrated in FIG. 17. However, it is not limited thereto, and the electronic receipt management server 4 may process the electronic accumulated receipt information in a different manner, and display all electronic accumulated receipt information without processing.

The programs which are executed in the POS terminal 1 and the electronic receipt management server 4 according to the embodiment are files of an installable format or an executable format. The programs are stored in a non-transitory computer readable recording medium such as a CD-ROM, a flexible disk (FD), a CD-R, and a digital versatile disk (DVD), and provided.

The programs which are executed in the POS terminal 1 and the electronic receipt management server 4 according to the embodiment may be configured so as to be stored in a computer which is connected to a network such as the Internet, and to be downloaded the programs through the network. The programs which are executed in the POS terminal 1 and the electronic receipt management server 4 according to the embodiment may be configured so as to be provided through a network such as the Internet or be distributed.

The programs which are executed in the POS terminal 1 and the electronic receipt management server 4 according to the embodiment may be configured so as to be stored in a ROM and the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing system in which data received from a plurality of data collection terminals are converted for efficient searching, comprising:
a first data collection terminal configured to collect transaction data in a first format and convert the transaction data into a structured format;
a second data collection terminal configured to collect transaction data in a second format and convert the transaction data into the structured format;
a central server connected to the first and second data collection terminals over a first network and configured to collect the transaction data in the structured format from the first and second data collection terminals and store the collected transaction data in a storage unit; and
a client device connected to the central server over a second network, the client device issuing one or more queries according to the structured format to the central server.

2. The data processing system according to claim 1, wherein
the first data collection terminal is operated by a first store in a mall, and
the second data collection terminal is operated by a second store in the mall.

3. The data processing system according to claim 2, wherein
the first data collection terminal is further configured to determine whether or not the transaction data in the first format includes a mall code of the mall, and converts the transaction data in the first format into the structured format when the transaction data in the first format is determined to include the mall code, and
the second data collection terminal is further configured to determine whether or not the transaction data in the second format includes the mall code, and converts the transaction data in the second format into the structured format when the transaction data in the second format is determined to include the mall code.

4. The data processing system according to claim 3, wherein
the first data collection terminal is further configured to cause the transaction data in the first format to be printed on a sheet, when the transaction data in the first format is determined to not include the mall code, and
the second data collection terminal is further configured to cause the transaction data in the second format to be printed on a sheet, when the transaction data in the second format is determined to not include the mall code.

5. The data processing system according to claim 2, wherein
the transaction data in the structured format is transmitted from the first data collection terminal together with a mall code and a store code of the first store,
the transaction data in the structured format is transmitted from the second data collection terminal together with the mall code and a store code of the second store, and
the central server stores the transaction data received from the first data collection terminal in association with the mall code and the store code of the first store, and the transaction data received from the second data collection terminal in association with the mall code and the store code of the second store.

6. The data processing system according to claim 5, wherein
one of the queries includes a mall code and a store code, and
the central server transmits transaction data associated with the mall code and the store code to the client device, in response to receiving the query.

7. The data processing system according to claim 1, wherein
the first data collection terminal is further configured to receive a command to generate the transaction data in the first format through an operation unit thereof, and the transaction data in the first format is generated in response to receiving the command, and
the second data collection terminal is further configured to receive a command to generate the transaction data in the second format through an operation unit thereof, and the transaction data in the second format is generated in response to receiving the command.

8. The data processing system according to claim 7, wherein
the transaction data in the first format includes data of one or more purchase transactions carried out through the first data collection terminal after a command received previously until a command received subsequently, and
the transaction data in the second format includes data of one or more purchase transactions carried out through the second data collection terminal after a command received previously until a command received subsequently.

9. The data processing system according to claim 1, wherein
the transaction data in the structured format is transmitted from the first data collection terminal to the central sever through a first store server, and
the transaction data in the structured format is transmitted from the second data collection terminal to the central sever through a second store server.

10. The data processing system according to claim 1, wherein
the first and second data collection terminals each attach at least one of a time stamp and an electronic signature to the transaction data in the structured format.

11. A method for providing data collected by a plurality of data collection terminals and converted for efficient searching, the method comprising:
converting transaction data in a first format generated by a first data collection terminal, into transaction data in a structured format;
converting transaction data in a second format generated by a second data collection terminal, into transaction data in the structured format;
storing the transaction data in the structured format in a central server connected to the first and second data collection terminals over a first network; and
transmitting, to a client device connected to the central server over a second network, the stored transaction data in response to receiving a query from the client device.

12. The method according to claim 11, wherein
the first data collection terminal is operated by a first store in a mall, and
the second data collection terminal is operated by a second store in the mall.

13. The method according to claim 12, further comprising:
determining whether or not the transaction data in the first format includes a mall code of the mall; and
determining whether or not the transaction data in the second format includes a mall code of the mall, wherein
the transaction data in the first format is converted upon the determination that the transaction data in the first format includes the mall code, and
the transaction data in the second format is converted upon the determination that the transaction data in the second format includes the mall code.

14. The method according to claim 13, further comprising:
printing the transaction data in the first format on a sheet; and
printing the transaction data in the second format on a sheet.

15. The method according to claim 12, further comprising:
the transaction data in the structured format converted from the transaction data in the first format is stored in association with a mall code and a store code of the first store,
the transaction data in the structured format converted from the transaction data in the second format is stored in association with the mall code and a store code of the second store.

16. The method according to claim 15, wherein
the query includes a mall code and a store code, and
the transaction data provided in response to the query is transaction data stored in association with the mall code and the store code included in the query.

17. The method according to claim 11, further comprising:
receiving a first command to generate the transaction data in the first format; and
receiving a second command to generate the transaction data in the second format, wherein
the transaction data in the first format is generated in response to receiving the first command, and
the transaction data in the second format is generated in response to receiving the second command.

18. The method according to claim 17, further comprising:
the transaction data in the first format includes data of one or more purchase transactions carried out through the first data collection terminal after a command received previously until a command received subsequently, and
the transaction data in the second format includes data of one or more purchase transactions carried out through the second data collection terminal after a command received previously until a command received subsequently.

19. The method according to claim 11, wherein
the transaction data in the structured format is transmitted from the first data collection terminal to a central sever through a first store server,
the transaction data in the structured format is transmitted from the second data collection terminal to the central sever through a second store server, and
the transaction data in the structured format from the first and second data collection terminals are stored in the central server.

20. The method according to claim 11, further comprising:
attaching at least one of a time stamp and an electronic signature to the transaction data in the structured format converted from the transaction data in the first format; and
attaching at least one of a time stamp and an electronic signature to the transaction data in the structured format converted from the transaction data in the second format.
